(19) United States
(12) Patent Application Publication
(10) Pub. No.: US 2009/0140551 A1
(43) Pub. Date: Jun. 4, 2009

(54) PILLAR FOR SUSPENSION OF A HINGED VEHICLE DOOR

(75) Inventor: Carl Stalhammar, Goteborg (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 12/295,876

(22) PCT Filed: Apr. 27, 2006
(86) PCT No.: PCT/SE06/00501

§ 371 Date: Oct. 3, 2008

(51) Int. Cl. B62D 25/04

(52) U.S. Cl. 296/193.06

(57) ABSTRACT

A pillar for suspension of a hinged vehicle door includes an inner panel and an outer panel. The inner and outer panels are spaced apart from each other. A spacing sleeve is arranged between the inner and outer panels. The spacing sleeve has at least one through hole for receiving a screw extending between the inner panel and the outer panel for attachment of a hinge flange to the pillar.

### BACKGROUND AND SUMMARY

The invention relates to a pillar for suspension of a hinged vehicle door.

The invention is applicable on vehicles, in particular trucks. The invention is, however, not restricted to trucks, but may also be used for example in wheel loaders, articulated haulers, excavators, and private cars.

Door stopper devices for vehicles serve to brake the movement of the door during opening or closing thereof. The door should have a behaviour allowing a controlled opening/closing of the door during also difficult conditions. The door stopper device prevents the door from being flung open or closed for example when the vehicle is parked on a slope or when there is windy weather. For trucks, it is particularly important to have a door braking device that brakes the movement of the door in case the door is not completely closed when the cab is tilted forwardly. Otherwise, there is a risk the door is flung open and thereby damages the hinges or other adjacent components.

Due to demands on good visibility performance and the design of the door so as to cover the entrance opening and adjacent steps, the doors of trucks tend to be larger and heavier. Thus, the brake torque to be provided by the door stopper device becomes larger. At the same time, the extension of the A-pillar in the X-direction is suitably reduced so as to obtain good visibility. This in turn makes it hard or impossible to use a conventional door stopper device which comprises for example a bar extending from the door to the cab of the vehicle in order to obtain the door brake functions.

The use of hinges having an integrated brake function is a known alternative solution to conventional door stopper devices. Such a design saves space and has further advantages in the production line by saving a lot of time.

However, such hinges having the sufficient brake torque for braking a heavy door will transmit very large forces and torques to the A-pillar and the door. This in turn can cause stress and deflection of the door frame part of the A-pillar, and thereby cause malfunction of the door mechanism. In an even worse case, the A-pillar can be permanently deformed and/or cracks can appear in the pillar when the door has been opened a couple of times.

It is desirable to provide a pillar for suspension of a hinged vehicle door of the kind referred to in the introduction, which pillar can be used also during difficult loading conditions, where relatively large forces and/or torques are transmitted to the pillar via one or more of the hinges of the door.

By the provision of a spacing sleeve arranged between the inner and outer panels, wherein the spacing sleeve has at least one through hole for receiving a screw extending between the inner panel and the outer panel for attachment of a hinge flange to the pillar, a hinge flange constituting part of the cab body can be attached to the pillar while increasing the distance from the hinge flange to the point of balance of the attachment means. This implies a more favourable load distribution on the door frame part of the pillar. The pillar can be designed with an increased torsional rigidity and strength. Furthermore, a longer life of such a pillar can be obtained. Such a pillar can be used for suspension of relatively heavy vehicle doors and absorption of movement energy of a vehicle door. For example, the pillar can be used together with door hinges having an integrated brake function.

Further advantages and advantageous features of the invention are disclosed in the following description.

### BRIEF DESCRIPTION OF THE DRAWINGS

With reference to the appended drawings, below follows a more detailed description of embodiments of the invention cited as examples.

In the drawings:

FIG. 1 is a perspective view of a pillar according to the invention,

FIG. 2 is across section view taken along H-II in FIG. 1,

FIG. 3 is an exploded view of the main components of the pillar illustrated in FIG. 1, and

FIG. 4 is an enlarged perspective view of the upper hinge illustrated in FIG. 1, where the inner and outer panels, and the spacing sleeve have been removed.

### DETAILED DESCRIPTION OF PREFERRED EMBODIMENTS

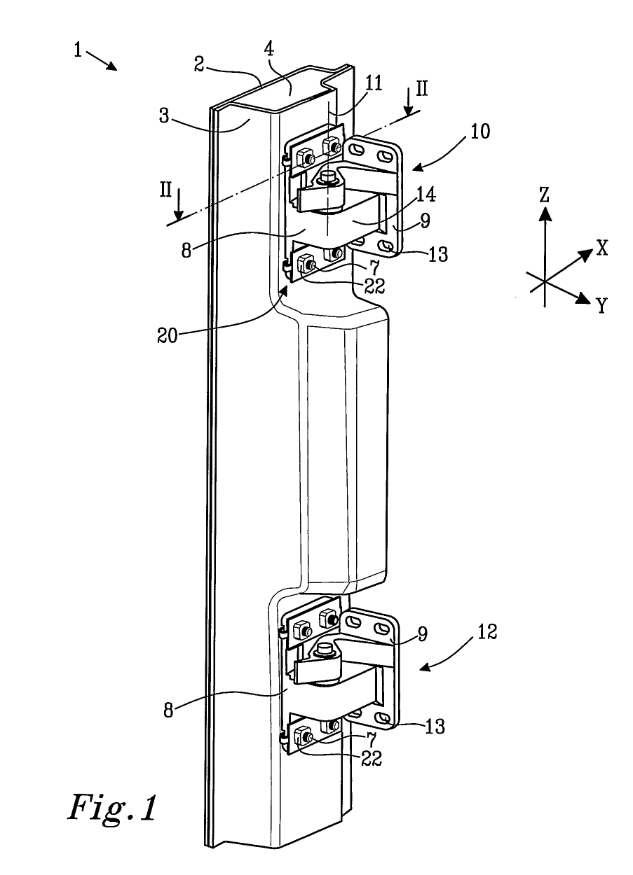

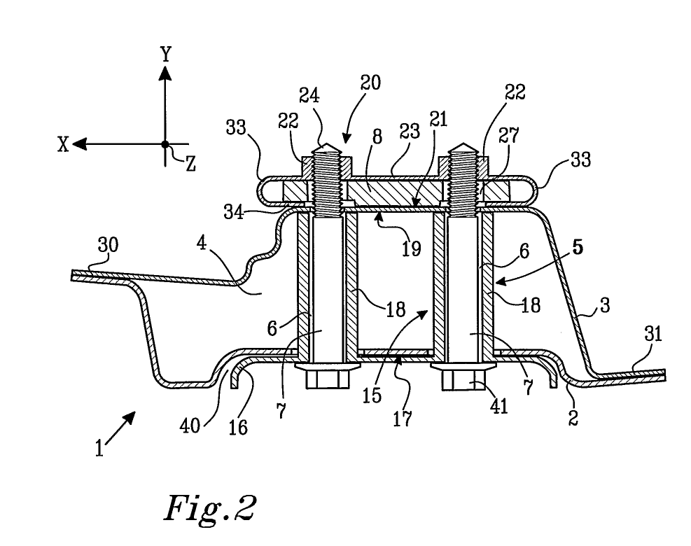

FIG. 1 is a perspective view illustrating a pillar I according to the invention. The pillar 1 is used for suspension of a hinged vehicle door (not illustrated). The pillar 1 comprises an inner panel 2 and an outer panel 3. The inner and outer panels 2, 3 are spaced apart from each other to form a space 4 inside the pillar 1. In the illustrated embodiment the pillar 1 is a so called A-pillar of a truck, and the inner panel 2 is an inner part of the A-pillar and the outer panel 3 is a door frame part. As appears from the cross section view in FIG. 2, taken along the line M-II in FIG. 1, a spacing sleeve 5 is arranged between the inner panel 2 and the outer panel 3. The spacing sleeve 5 has at least one through hole 6 for receiving a screw 7 extending between the inner panel 2 and the outer panel 3 for attachment of a hinge flange 8 to the pillar 1. In addition to the screw joints, the inner panel and the outer panel are preferably interconnected to each other, for example along the edges 30, 31 , by soldering, spot welding or other welding, riveting or any other suitable method. Also the spacing sleeve can be fastened to the pillar 1 by spot welding the spacing sleeve 5 and the inner panel 2 to each other. The inner panel, the outer panel as well as the spacing sleeve are preferably made by any metal, such as steel or aluminium. Although the distance between the panels 2, 3, i.e. the length of the spacing sleeve 5, and the thicknesses of the panels, are dependent of the current application and load, the spacing sleeve length is preferably several times the thicknesses of the panels, and more preferably 5-50 times the panel thickness, and of often 20-40 times the panel thickness.

As appears from FIG. 1, the hinge flange 8 and a second corresponding hinge flange 9 form an upper hinge 10. The hinge flange 8 and the second hinge flange 9 are connected to each other via a substantially vertical pivot axis 11 for pivot motion relative to each other. Furthermore, a second lower hinge 12 comprising the same components as the 5 upper hinge 10 is also arranged in the pillar 1. A vehicle door can be connected to the pillar 1 by means of the second hinge flanges 9 having bores 13, preferably oval bores, for attachment of the door by some fastening means, such as screws or similar. The hinge flange 8 and/or the second corresponding hinge flange 9 can be provided with means 14 for braking the door pivot motion. Such a braking means integrated in the hinges is known from prior art and is available on the market.

Although the spacing sleeve 5 illustrated in FIGS. 1 and 2 has four said through holes 6 and thus four screws 7, in another embodiment the number of through holes could of course be different. The spacing sleeve 5 comprises preferably at least one first portion 15 and a second portion 16, and the first and second portions 15, 16 are connected to each other. The first and second portions are connected to each other by any suitable method, or made in one piece, so as to form an integral continuous component. The first portion 15 is arranged inside the space 4 between the inner panel 2 and the outer panel 3, and the second portion 16 is arranged outside the space 4. The first portion 15 has an extension from the inner panel 2 to the outer panel 3.

The second portion 16, preferably a flange, is suitably arranged to abut against the outside 17 of the inner panel 2 as illustrated, or against the outside of the outer panel. The first portion 15 can be one continuous piece, such as a plate having one or more through holes, or preferably two or more of said at least one first portion 15 can be used. Advantageously, several first portions 15 in the form of separate spacing tubes 18 each having a through hole 6 are used. For example, four of said spacing tubes 18 can be used. Such a design reduces weight compare to a continuous plate for instance. Each spacing tube 18, which can be a cylinder provided with a circular cross section and a through hole 6, have an extension from the second portion 16 to the outer panel 3, and abuts against the inside 19 of the outer panel 3. By means of the second portion 16 the spacing sleeve 5 abuts also against the outside 17 of the inner panel 2. A nut mechanism 20 which cooperates with the screws 7 is arranged for attachment of the hinge flange 8 to the pillar 1, preferably to the door frame part 3 of an A-pillar.

In FIGS. 1 and 2 two nut mechanisms 20 are arranged outside the space 4 for attachment of the hinge flange 8 between the nut mechanism 20 and the outside 21 of the outer panel 3 of the pillar 1. Each nut mechanism 20 has two nuts 22 fixedly arranged relative to each other on a connection portion 23, such as a plate or similar. Thus, each nut mechanism 20 is used for receiving two screws 7. Preferably, at least any screw 7 has a conical end 24 for centring the nut mechanism 20 when the hinge flange 8 is mounted.

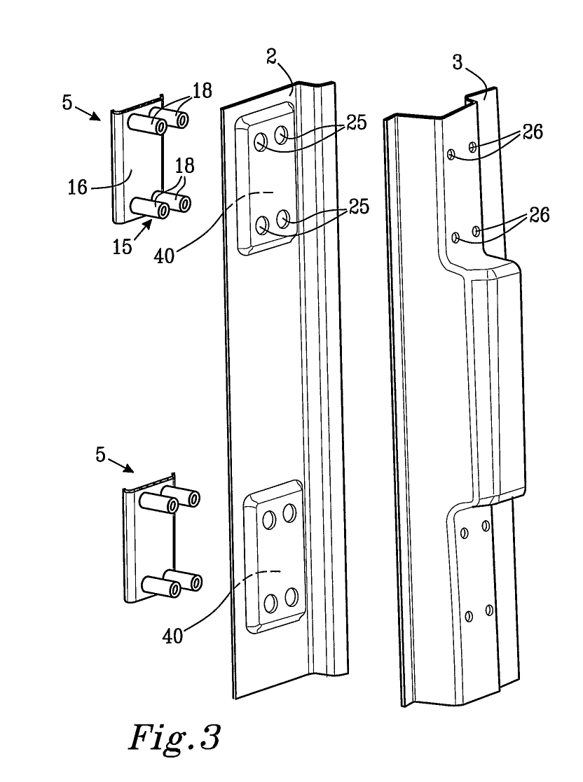

As illustrated in FIG. 3, the inner panel 2 has bores 25 for receiving the first portions 15 of the spacing sleeve 5. The size of the bores 25 is adapted to the size of the spacing tubes 18 to be inserted between the inner and outer panels 2, 3. The outer panel 3 has bores 26 for receiving the screws 7. These bores 26 have a smaller size (see also FIG. 2) so as to let the screws 7 pass through at the same time as the respective spacing tube 18 has support against the inside 19 of the outer panel 3. Furthermore, the inner panel can be designed with depressions 40 for accommodating the second portion 16 of the spacing sleeve 5. Such depressions 40 can be made by pressing or punching the inner panel. By the depressions the screw heads 41 of the screws 7 can be hidden and/or be flush mounted with respect to the surrounding outer surface of the inner panel 2.

The hinge flange 8 is provided with bores 27 for receiving the screws 7. The hinge flange 8 may have square holes 27 for receiving the screws 7 and for adjustment of the hinge flange 8 relative to the pillar 1 in for example X-direction or Z-direction. In other words, the hinge flange 8 can be adjusted in a geometrical plane. For adjustment of the hinges 10, 12 in a direction perpendicularly to the geometrical plane, i.e. in the third direction such as the Y-direction, the relative positions between the further hinge flange 9 and the door can be altered by using the oval bores 13 of the second hinge flange 9.

The mounting of a vehicle door can be accomplished as follows:

The pillar 1 is created from the inner panel 2, the outer panel 3 and the spacing sleeves 5. The door is brought to the pillar 1. The hinges 10, 12 comprising both hinge halves 8, 9 can be pre-mounted on the door. Also the nut mechanism 20 can be pre-mounted on the hinge flange 8 to be attached to the pillar 1. Thereafter screws 7 are inserted from the inside of the cab in the spacing sleeve 5 and tightened by using the nut mechanism 20 which is centred relative to the screws by the conical ends 24 of the screws 7. The square holes 27 in the hinge flange 8 and the oval bores 13 in the second hinge 9 flange allow adjustment of the door relative to the cab in all three dimensions X, Y and Z. Thus, the door can be mounted from inside the cab which in turn implies that the door and/or a corner plate can be arranged to cover the hinges 10, 12 since no accessibility from outside the cab is required for tightening the screws 7. Accordingly, a greater design freedom is also obtained.

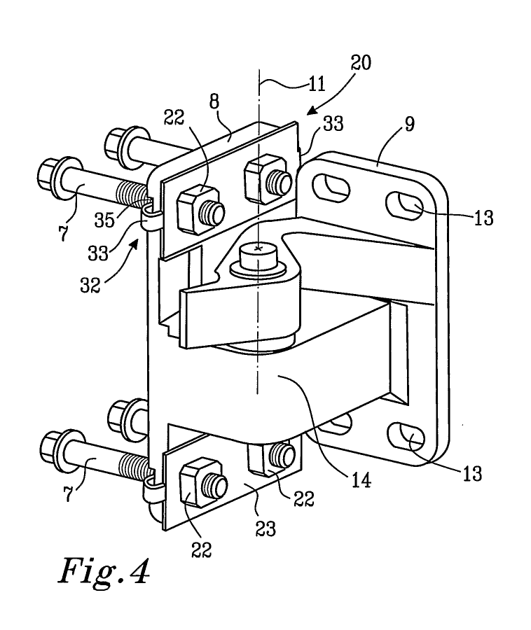

FIG. 4 illustrates an enlarged perspective view of the upper hinge illustrated in FIG. 1, where the inner and outer panels and the spacing sleeve have been removed for the sake of clarity. In mounting the door on the cab or for accomplishing service on a door already mounted, the hinge halves can be disconnected from each other. The hinge flange 8 and the second hinge flange 9 can be disconnected from each other at the pivot axis 11 before or after the door has been mounted if so is desired. A further advantage during the mounting operation can be achieved if the nut mechanism 20 is provided with a clamping device 32 for keeping the nut mechanism 20 in a certain position relative to the hinge flange 8. See also FIG. 2. The clamping device can comprise one or two, preferably narrow arms 33 extending from the connection portion 23. These arms 33 can be bent around the hinge flange 8 to the back side 34 of the hinge flange 8 so as to keep the nut mechanism 20 in the desired position. On the back side 34 of the hinge flange 8 a groove 35 having a width and depth corresponding to the width and thickness, respectively, of the arms 33, can be arranged for receiving the arms 33 and thereby ensure the position of the nut mechanism 20 relative to the hinge flange 8.

It is to be understood that the present invention is not limited to the embodiments described above and illustrated in the drawings; rather, the skilled person will recognize that many changes and modifications may be made within the scope of the appended claims.

1. A pillar (1) for suspension of a hinged vehicle door, comprising an inner panel (2) and an outer panel (3), the inner and outer panels (2, 3) being spaced apart from each other, characterized in that a spacing sleeve (5) is arranged between the inner and outer panels (2, 3), the spacing sleeve (5) having at least one through hole (6) for receiving a screw (7) extending between the inner panel (2) and the outer panel (3) for attachment of a hinge flange (8) to the pillar (1).

2. A pillar according to claim 1, characterized in that the spacing sleeve (5) comprises at least one first portion (15) and a second portion (16) connected to each other, the first portion (15) being arranged inside the space (4) between the inner panel (2) and the outer panel (3) and the second portion (16) being arranged outside the space (4).

3. A pillar according to claim 2, characterized in that the first and second portions (15, 16) are made in one piece.

4. A pillar according to claim 2 or 3, characterized in that the second portion (16) is arranged to abut against the outside (17) of one of the inner panel (2) and the outer panel (3).

5. A pillar according to claim 4, characterized in that the second portion (16) is arranged to abut against the inner panel (2).

6. A pillar according to any of claims 2-5, characterized in that the first portion (15) is arranged to abut against the inside (19) of one of the inner panel and the outer panel (3).

7. A pillar according to claim 6, characterized in that the first portion (15) is arranged to abut against the outer panel (3).

8. A pillar according to any of claims 2-7, characterized in that the pillar (1) comprises two or more of said at least one first portion (15), each first portion being a separate spacing tube (18).

9. A pillar according to claim 8, characterized in that the pillar (1) comprises four said spacing tubes (18).

10. A pillar according to any preceding claim, characterized in that the spacing sleeve (5) has two or more said through holes (6).

11. A pillar according to claim 10, characterized in that the spacing sleeve (5) has four said through holes (6).

12. A pillar according to any preceding claim, characterized in that the pillar (1) comprises at least one nut mechanism (20) cooperating with said at least one screw (7) for attachment of the hinge flange (8).

13. A pillar according to claim 12, characterized in that the nut mechanism (20) is arranged outside the space (4) for attachment of the hinge flange (8) between the nut mechanism (20) and the outside (21) of one of the inner panel and the outer panel (3).

14. A pillar according to claim 13, characterized in that the nut mechanism (20) is arranged for attachment of the hinge flange (8) between the nut mechanism (20) and the outer panel (3).

15. A pillar according to any of claims 12-14, characterized in that the nut mechanism (20) comprises two nuts (22) fixedly arranged relative to each other on a connection portion (23).

16. A pillar according to any of claims 12-15, characterized in that the pillar (1) comprises two said nut mechanisms (20).

17. A pillar according to any of claims 12-16, characterized in that the pillar (1) comprises said at least one screw (7) having a conical end (24) for centring the nut mechanism (20).

18. A pillar according to any preceding claim, characterized in that the pillar (1) comprises said hinge flange (8) having square holes (27) for receiving said at least one screw (7) and for allowing adjustment of the hinge flange (8) relative to the pillar in X-direction or Z-direction.

19. A pillar according to any preceding claim, characterized in that the pillar (1) comprises said hinge flange (8) and a second corresponding hinge flange (9) which form a hinge (10), the hinge having a pivot axis (11) for pivot motion of the hinge flange (8) and the second hinge flange (9) relative to each other, the hinge flange (8) and/or the second hinge flange (9) having means (14) for braking the pivot motion.
